(19) United States
(12) Patent Application Publication
(10) Pub. No.: US 2005/0269950 A1
(43) Pub. Date: Dec. 8, 2005

(54) Electroluminescent display, electronic device comprising such a display and method of manufacturing an electroluminescent display

(75) Inventors: Andrea Giraldo, Eindhoven (NL); Herbert Lifka, Eindhoven (NL); Mark Thomas Johnson, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Noninklijke Philips Electronics N.V., NL- 5621 BA Eindhoven (NL)

(21) Appl. No.: 10/521,656

(22) PCT Filed: Jul. 8, 2003
(86) PCT No.: PCT/IB03/03066

§ 371 Date: Jan. 18, 2005

(30) Foreign Application Priority Data
Jul. 23, 2002 (EP) 02077999.7

(51) Int. Cl. H05B 33/00

(52) U.S. Cl. 313/509

(57) ABSTRACT

The invention relates to an electroluminescent display comprising at least one display pixel, the display pixel comprising at least a substrate, a first electrode deposited on or across the substrate, an electroluminescent layer, and a second electrode. The display pixel further comprises at least one insulating structure within the display pixel adapted to enhance the light output from said display pixel. The light output enhancing structure can be used to generate images with different brightness levels.

The invention relates to an electroluminescent display comprising at least one display pixel, said display pixel comprising at least:
a substrate,
a first electrode deposited on or across the substrate,
an electroluminescent layer, and
a second electrode.

The invention further relates to an electronic device comprising such an electroluminescent display and to a method of manufacturing an electroluminescent display.

Japanese Patent Publication 11-214162 discloses an electroluminescent display comprising display pixels formed on a substrate. The display pixels consist of an insulating layer and an electroluminescent layer sandwiched between first and second electrodes. The light output of the electroluminescent device is improved by providing the first electrode with a plurality of fine protruding projections. These projections give rise to an inclination of parts of the second electrode. The inclined surfaces of the second electrode contribute to the efficiency of the light output of the various display pixels of the electroluminescent display.

However, electroluminescent displays that aim at optimising the light output often have display structures which require several additional manufacturing steps.

It is an object of the invention to provide an electroluminescent display which improves the light output while no or only few additional manufacturing steps are required. Alternatively, a smaller display pixel aperture can be used for the same light output, which is beneficial for the robustness of the manufacturing process, or a smaller driving current for the display pixel may be applied, as a result of which power can be reduced or degradation is reduced.

This object is achieved by providing an electroluminescent display which is characterized in that said display pixel further comprises at least one insulating structure within said display pixel adapted to enhance the light output from said display pixel. This insulating structure is hereinafter also referred to as a light output enhancing structure (LOES).

Several structuring steps are performed during the manufacturing of an electroluminescent display. The insulating structure can be obtained during one of the conventional manufacturing steps, so no additional process steps are required. The insulating structure is preferably obtained from the insulating layer separating the first and the second electrode. In this embodiment, the insulating structure can be realised in the same step as the step in which the contact holes in the insulating layer are created in order to establish contact between the first electrode and the luminescent layer to be deposited. The insulating structure can also be obtained by structuring one or more of the top substrate layers. This embodiment is easy to manufacture as well.

In a preferred embodiment of the invention, the display pixel comprises at least one side light output enhancing structure (SLOES). The SLOES allows the capture of light trying to escape the pixel to an adjacent pixel. Such a SLOES can be combined with a LOES within the display pixel in order to improve the light output efficiency even further.

In a preferred embodiment of the invention, the SLOES comprises walls that are slanted in order to increase the light output of the display pixel, while the output of light received from adjacent display pixels of the electroluminescent display is prevented from emerging from that display pixel. In this embodiment, the SLOES thus has multiple tasks to optimally contribute to the performance of the electroluminescent display.

In a preferred embodiment of the invention, either the substrate or the top substrate layer or layers on which the display pixels are formed is thin as compared to the lateral dimensions of the pixel. This feature enhances the output of light from a display pixel because a reduction of the substrate thickness increases the probability of light that exhibits a total internal reflection (TIR) at the interfaces of the top substrate layers that are unmatched with respect to the refractive index or at the substrate-air interface to be reflected by the LOES or SLOES before leaving the display pixel.

In a preferred embodiment of the invention, the LOES and SLOES provide areas with different brightness levels within a display pixel if the electroluminescent display is operated. These areas can be used to obtain images, such as graphics or icons, with different brightness levels on the display as a result of which more vivid images can be displayed or alternatively power can be reduced.

It will be appreciated that the previous embodiments or aspects of the previous embodiments of the invention can be combined.

The invention further relates to an electronic device comprising an electroluminescent display according to the invention. Such a device may be e.g. a mobile phone or a Personal Digital Assistant (PDA).

The invention further relates to a method of manufacturing an electroluminescent display comprising at least one display pixel, the method at least comprising the steps of:
providing a substrate,
depositing a first electrode layer on or across the substrate,
depositing an electroluminescent layer on or across the first electrode layer,
depositing a second electrode layer on or across the electroluminescent layer, wherein the method further comprises a structuring step wherein at least one insulating structure is provided within said display pixel adapted to enhance the light output from said display pixel.

An advantage of this method relates to the fact that the structuring step can often be integrated in the conventional manufacturing process or requires only one or few additional or modified process steps. In a preferred embodiment, the structuring step is performed in an insulating layer deposited in or across said first electrode. The structuring step can then be combined with the provision of contact holes in this intermediate layer in order to establish contact between the first electrode and the luminescent layer to be deposited afterwards. Thus, no additional manufacturing step is required for obtaining an electroluminescent display with an enhanced light output.

In an embodiment, the thickness of layers in the electroluminescent display is varied in order to control the effects that enhance the light output. In this way, optimal control can be achieved.

U.S. Pat. No. 6,091,195 discloses a colour display with a mesa pixel configuration that captures light by mirrors or total internal reflection at the edges of the pixels. The mirrors exhibit an angle with the substrate such that light incident on these mirrors leaves the display pixel, thus increasing the light output. Manufacturing of such an electroluminescent display is complicated and requires additional process steps as compared to the electroluminescent display according to the invention.

The embodiments of the invention will be described in more detail below with reference to the attached drawing, in which

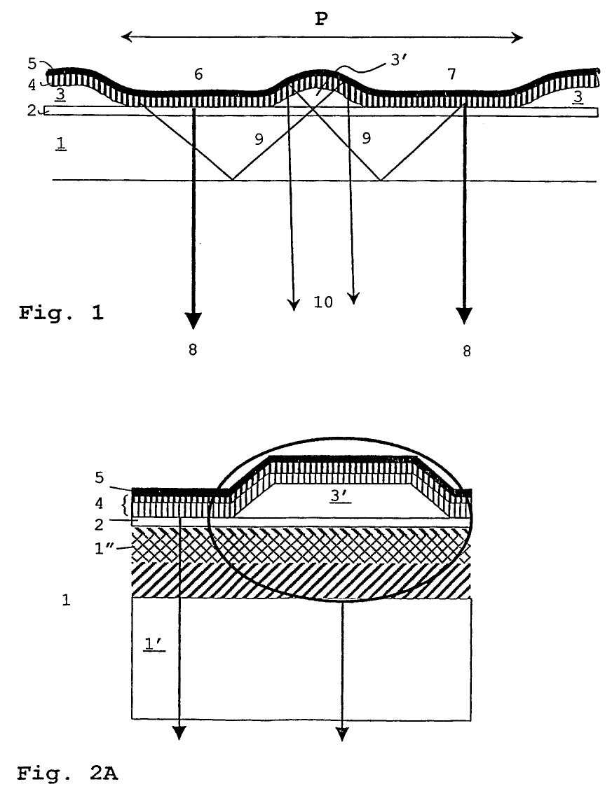

FIG. 1 shows a display pixel according to a first embodiment of the invention.

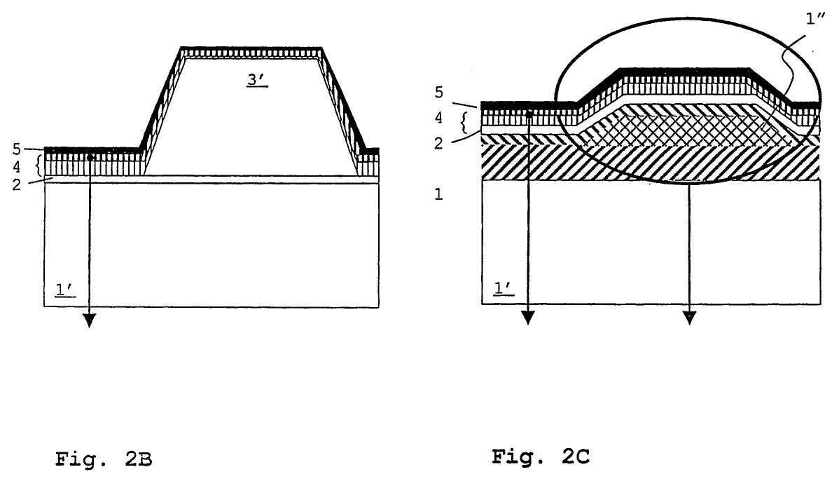

FIGS. 2A, B and C show a LOES comprising different layer structures.

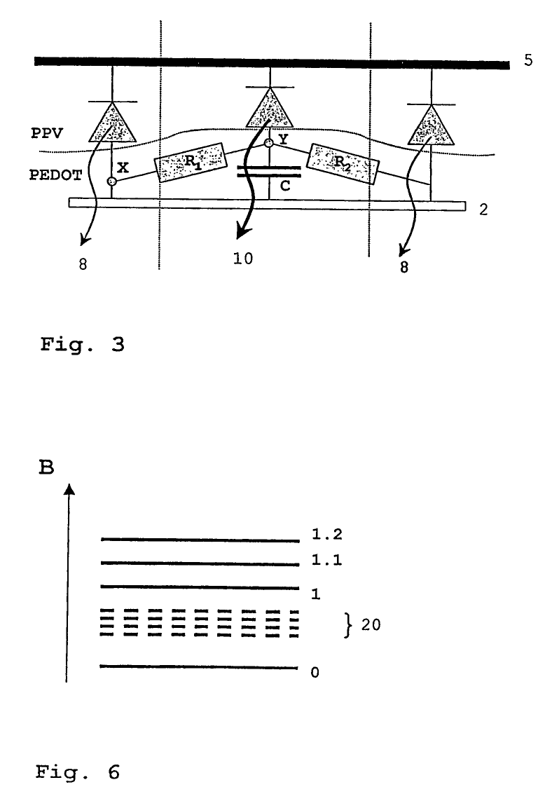

FIG. 3 shows an electrical scheme representing a display pixel.

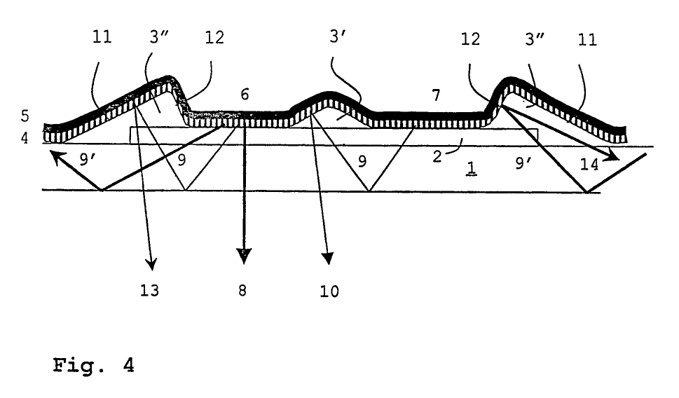

FIG. 4 shows a display pixel according to a second embodiment of the invention.

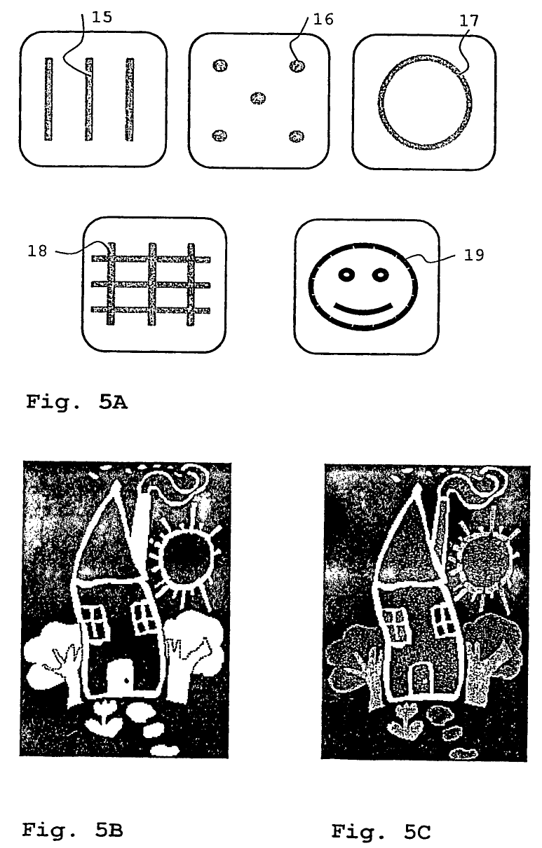

FIGS. 5A, B and C show various in-pixel images.

FIG. 6 shows a diagram illustrating the various in-pixel brightness levels.

FIG. 1 is a part of a cross-section of an active matrix luminescent display (not to scale) according to a first embodiment of the invention. The active display comprises a substrate 1 carrying a first electrode 2, a dielectric insulating layer 3, a luminescent layer 4 and a second reflective electrode 5. In the configuration shown, the electroluminescent display exhibits a display pixel P comprising sub-pixels 6, 7.

The substrate 1 may comprise a base substrate 1′ and several top substrate layers, as will be further illustrated in FIGS. 2A-C. The base substrate is preferably made of a transparent material such as glass or plastic. The total thickness of the substrate ranges from 100-700 μm, while the total thickness of the top substrate layers is typically 1-3 μm.

The first electrode 2 is transparent with respect to the light generated in the luminescent layer 4. Typically, the first electrode 2 is made from Indium-Tin-Oxide (ITO), but different conductive and transparent materials can be alternatively used. During the manufacturing of the electroluminescent display, an insulating layer 3 is deposited on top of the first electrode 2 and subsequently removed on the sites where the display pixel P is to be formed. As an example, the dielectric insulating layer 3 is made of silicon nitride or silicon oxide and has a thickness of 0.5 μm.

The first electrode 2 and dielectric insulating layer 3 are covered by the electroluminescent layer 4 or a layer comprising an electroluminescent material, such as certain organic materials like poly-p-phenylenes (PPV) or derivatives thereof. The electroluminescent layer 4 can be deposited by using vacuum deposition, chemical vapour deposition or fluid-using techniques such as spin-coating, dip-coating or ink-jet printing. Typically in a polymer organic electroluminescent display, an additional layer (not shown) made from conductive polymers (polyaniline (PANI) or a poly-3,4-ethylenedioxythiopene (PEDOT)) is applied between the first electrode 2 and the electroluminescent layer 4.

The electroluminescent layer 4 is covered by the second electrode 5. The second electrode is a metal and is highly reflective. From a top view of the electroluminescent display, the second electrodes appear as either metal stripes across the various display pixels or as a substantially continuous, uninterrupted, layer.

It is noted that while FIG. 1 is a cross-section of an active electroluminescent display, the invention and its advantages also apply to passive electroluminescent displays and to monochrome and colour displays. In passive displays, an additional dielectric layer may be introduced into the manufacturing process, because the emissive layers are common to active and passive matrix displays. The process can be generalized, even for small molecule organic electroluminescent displays.

In operating the electroluminescent display shown in FIG. 1, voltages can be applied to the display pixels P by display control means (not shown; an example is provided by the article “Passive and active matrix addressed polymer light-emitting diode displays”, Proceedings SPIE Conference Vol. 4295, p. 134, 2001 which is incorporated herewith by reference.) If no voltage is applied to the electrodes 2, 5, no light is generated in the luminescent layer 4 and the display pixel P is in the off-state. If a current or a voltage is applied to the luminescent layer 4, light is generated in this layer 4 or from this pixel, which light leaves the display pixel P through the transparent first electrode 2 and the transparent substrate 1 into the air, resulting in a direct image of the display pixel P, indicated by the light rays 8. However, the light generated in the display pixel P is emitted Lambertianally, i.e. the light emission is almost distributed equally in each direction. Therefore, light rays are emitted from the display sub-pixels 6, 7 that do not result in a direct image 8 but channel through the substrate layers under certain conditions to be explained below.

The display pixel P shown in FIG. 1 comprises a light output enhancing structure (LOES) 3′. The LOES 3′ is properly patterned so as to form a small insulating structure in the insulating layer 3 that separates the sub-pixels 6 and 7. Some light rays from the display sub-pixels 6, 7 exhibit a total internal reflection (TIR) at the interfaces between the top substrate layers and the base substrate of the substrate 1 or at the interface of the substrate and the air and are subsequently reflected from the second electrode 5. These light rays, hereinafter also referred to as TIR-rays, are indicated by reference numeral 9. Due to the presence of the LOES 3′, the TIR-rays 9 are reflected by the second electrode 5 into the air, as a result of which the total amount of light of the display pixel P is enhanced. This enhancement of the light output is represented by the light rays 10 in FIG. 1.

The LOES 3′ can be realised in the active matrix manufacturing process without any additional process steps. During the manufacture of the active matrix electroluminescent display, the top dielectric insulating layer 3 is etched in order to create the boundaries of the display pixel P. These boundaries define a contact hole between the first electrode 2 and the electroluminescent layer 4 that is covered by the second electrode 5. The LOES 3′ can be obtained by modifying the etching process by using a different mask for defining the areas to be removed during the etching process.

The light output enhancement by the LOES 3′ and the second electrode 5 results in the phenomenon that the light output from the LOES region is higher than from the surrounding region, despite the fact that no light is actually generated in the luminescent layer 4 above the LOES 3′ except for light generation due to a local increase in the current density at the base of the LOES 3′, as will be clarified with reference to FIGS. 2 and 3 below. Thus, while the LOES 3′ reduces the aperture, i.e. the light-emitting area across the display pixel area in percentages, of the display pixel P, the overall light output is enhanced as compared to a display pixel without a LOES 3′.

The enhancement of the light output can be optimised by decreasing the thickness of the substrate 1. If the substrate 1 is too thick, many TIR-rays 9 will first be incident on adjacent display pixels of the electroluminescent display and will not be coupled out or even generate optical crosstalk between these adjacent display pixels. The output of the TIR-rays 9 is enhanced by reducing the thickness of the substrate 1, as for a thin substrate most TIR-rays 9 will encounter the LOBS 3′ and reflect on the second electrode 5 before leaving the area of the display pixel P.

FIGS. 2A-C show three embodiments of a LOES. The structures shown have a substrate 1 comprising a base substrate 1′ on top of which various top substrate layers such as a SiO₂ layer 1″ of e.g. 0.2 μm are deposited. The top substrate layers from the base substrate 1′ of substrate 1 upwards may comprise a SiN-layer of e.g. 0.2 μm, layer 1″, a SiN-layer of 0.1 μm and a SiO₂-layer of 0.05 μm, respectively. In FIG. 2A, the LOES 3′ as illustrated in FIG. 1 is shown in more detail. The luminescent layer 4 comprises a lower PEDOT layer of e.g. 0.2 μm and an upper PPV layer of e.g. 0.1 μm. FIG. 2B shows a LOES 3′ that does not enhance the light output because no TIR occurs at the substrate-air interface so that light remains within the display pixel P (since e.g. the substrate may be too thick, a much thinner substrate may have resulted in TIR within the display pixel) or at the interface of the first electrode 2 and the substrate 1 (because no top substrate layers are provided). In FIG. 2C, the LOES is provided by structuring one of the top substrate layers, e.g. SiO₂ layer 1″. It is to be noted that not all top substrate layers shown in FIG. 2C are needed as long as a top substrate layer structure can be provided. Light output enhancement is obtained as shown by the arrow because the emitting area is increased due to structuring the top substrate layer 1″.

In FIG. 3, an electric circuit representation is given of a display pixel P comprising a LOES 3′ as shown in FIG. 2A. The dashed line shows the interface of the PPV and the PEDOT layer. This representation illustrates that, besides the optical enhancement of the light output as discussed above and shown in FIG. 1, an electrical effect may result in and/or contribute to the light output enhancement as well. The resistances R₁ and R₂ represent the lateral resistance of the PEDOT layer; the capacitance C represents the capacitance of PEDOT/SiN/ITO. The diodes represent the emissive behaviour of the PPV layer, if activated. The voltage at point X is always higher than at point Y due to the resistance and capacitance effects. However, if the PPV layer above Y is thinner than above X, the light output from the middle diode, i.e. the luminescent layer above the LOES 3′ is larger. The optical effect and the electrical effect are tuneable, i.e. the contribution of the effects to the light output or relative to each other can be determined. This tuning can be achieved in particular by varying the layer thickness of the top substrate layers of the substrate 1 for the optical effect and of the PEDOT and PPV layers 4 for the electrical effect. In this way, the effects that enhance the light output can be controlled.

FIG. 4 shows a second embodiment of the invention Identical reference numerals have been used to designate identical parts that are common to FIG. 1. Apart from the direct light output 8, the TIR-rays 9 again reflect partly at the second electrode 5 due to the LOES 3′ so that the overall light output is enhanced. In addition, the embodiment of the invention shown in FIG. 4 comprises side light output enhancing structures (SLOES) 3″. As shown by the light ray 13, these SLOES 3″ contribute to the enhancement of the light output as well.

The SLOES 3″ comprises slanting walls 11, 12 with respect to the substrate 1. Since the light generated in the luminescent layer 4 that exhibits TIR at the interface of the substrate 1 and the air is not entirely reflected towards the LOES 3′, TIR-rays 9 may encounter the SLOES 3″. If the TIR-rays 9 are incident on the slanting wall 11, the light output is enhanced as shown by light ray 13. Thus, in addition to TIR-rays 9 reflected at the second electrode into the air in the region of LOBS 3′ also TIR-rays 9 trying to escape from the display pixel P are reflected by the second electrode into the air due to the presence of the SLOES 3″.

If TIR-rays 9′ miss the slanting wall 11 of the SLOES 3″, they may channel through the substrate 1 to an adjacent display pixel. In order to force these TIR-rays 9′ back to the adjacent display pixel from which they originate, as shown by the light ray 14, the SLOES 3″ are provided with slanting side walls 12. The light ray 14 returns to the adjacent display pixel and may contribute to the light output for that adjacent display pixel.

In order to further reduce the channelling of TIR-rays 9′ to adjacent pixels, a black mask (e.g. a black resist or polysilicon) can be placed between the display pixels. Such a black mask may absorb the TIR-rays 9′ before they channel to an adjacent pixel.

It will be appreciated that the SLOES 3″ can be applied at the sides of the display pixel P alone, i.e. without a LOES 3′.

FIGS. 5A, B and C show different images, such as graphics or icons that may be generated within a display pixel P on the electroluminescent display by applying LOES 3′. Icons may be an essential part of a display, especially in mobile applications. The icons may represent a battery, a letter or face which is usually present on the display of a mobile phone or PDA. The examples shown in FIG. 5A comprise stripes 15, dots 16, an annular ring 17, a checkerboard 18 and a smiley-icon 19. More complicated images can be generated as well. FIG. 5B shows a conventional graphic comprising a one-bit image (i.e. an on-state for a bright area and an off-state for a dark area in the image) on an organic LED display. Intermediate levels of brightness B are conventionally obtained by using area ratio techniques such as light-absorbing structures in the display pixels or by removing specific parts of electrodes of the display pixel. These intermediate levels 20 are shown in FIG. 6. FIG. 5C shows an image that can be generated by applying LOES 3′ and/or SLOES 3″. The preferred embodiment of the invention provides the possibility of having areas in images with a brightness B above the principal brightness of 1 obtained in the conventional on-state of a display pixel, as shown in FIG. 6 by brightness levels B=1.1 and B=1.2. In this way, an image comprising more brightness levels (i.e. 3-bit) can be obtained, resulting in a more vivid and attractive image on the electroluminescent display. This result is achieved without additional patterning of the icons or more connections that lead to driver complexity for the electroluminescent display. The different brightness levels B are achieved by optical structures such as the LOES 3′ built within the display pixel structure itself.

For the purpose of teaching the invention, preferred embodiments of the display device and the electronic device comprising such a display device have been described above. It will be apparent to the person skilled in the art that other alternative and equivalent embodiments of the invention can be conceived and reduced to practice without departing from the true spirit of the invention, the scope of the invention being only limited by the claims.

1. An electroluminescent display comprising at least one display pixel (P), said display pixel (P) comprising at least:
a substrate (1);
a first electrode (2) deposited on or across said substrate (1);
an electroluminescent layer (4), and
a second electrode (5),
characterized in that said display pixel (P) further comprises at least one insulating structure (3′) within said display pixel (P) adapted to enhance the light output from said display pixel (P).

2. An electroluminescent display as claimed in claim 1, wherein said insulating structure (3′) is part of a dielectric insulating layer (3) deposited on or across the first electrode (2).

3. An electroluminescent display as claimed in claim 1, wherein said insulating structure is part of said substrate (1) as a top substrate layer (1″).

4. An electroluminescent display as claimed in claim 2 or 3, wherein said second electrode (5) comprises a reflective layer and said light output is enhanced by reflection at said reflective layer.

5. An electroluminescent display as claimed in claim 1, wherein said display pixel (P) comprises at least one side light output enhancing structure (3″).

6. An electroluminescent display as claimed in claim 5, wherein said side light output enhancing structure (3″) comprises walls (11,12) which are slanted to enhance the light output for light (9) generated in said electroluminescent layer of said display pixel (P) and to prevent output of light (9′) received from other display pixels of said electroluminescent display.

7. An electroluminescent display as claimed in claim 1, wherein said substrate (1) is adapted by at least one top substrate layer so as to allow total internal reflection for some light output of said display pixel (P).

8. An electroluminescent display as claimed in claim 7, wherein said substrate is thin compared to a lateral dimension of said display pixel (P).

9. An electroluminescent display as claimed in claim 7, wherein said substrate comprises top substrate layers adapted to allow said total internal reflection.

10. An electroluminescent display as claimed in any one of the preceding claims, wherein, in operation, said insulating structure (3′) and/or said side light output enhancing structure (3″) provide areas of different brightness levels B within said display pixel P.

11. An electroluminescent display as claimed in claim 10, wherein said areas are patterned to provide images (15,16,17,18,19) with different brightness levels B.

12. An electronic device comprising an electroluminescent display as claimed in any one of the preceding claims.

13. A method of manufacturing an electroluminescent display comprising at least one display pixel (P), the method at least comprising the steps of:
providing a substrate (1)
depositing a first electrode layer (2) on or across said substrate (1);
depositing an electroluminescent layer (4) on or across said first electrode layer (2);
depositing a second electrode layer (5) on or across said electroluminescent layer (4), characterized in that said method further comprises a structuring step wherein at least one insulating structure (3′; 3″; 1″) is provided within said display pixel (P) adapted to enhance the light output from said display pixel (P).

14. A method as claimed in claim 13, wherein said structuring step is performed in an insulating layer (3) deposited in or across said first electrode (2).

15. A method as claimed in claim 13, wherein said structuring step is performed in said substrate (1).

16. A method as claimed in claim 13, wherein said substrate (1) comprises top substrate layers and said electroluminescent layer (4) comprises emissive layers, the method comprising the step of tuning the thickness of the top substrate layers and emissive layers so as to control the effects that enhance the light output.
